(19) United States
(12) Patent Application Publication
(10) Pub. No.: US 2025/0137205 A1
(43) Pub. Date: May 1, 2025

(54) RAIL BASED MOBILITY SYSTEMS AND METHODS OF INSTALLATION AND USE

(71) Applicant: Jacob Keller Gearhart, Portland, OR (US)

(72) Inventor: Jacob Keller Gearhart, Portland, OR (US)

(21) Appl. No.: 18/682,499

(22) PCT Filed: Aug. 25, 2022
(86) PCT No.: PCT/US2022/041600

§ 371 Date: Feb. 9, 2024

Related U.S. Application Data
(60) Provisional application No. 63/237,028, filed on Aug. 25, 2021.

(51) Int. Cl. E01B 25/28; B60L 5/38; B61D 3/18; E01B 7/18

(52) U.S. Cl. CPC E01B 25/28; B60L 5/38; B61D 3/18; E01B 7/18

(57) ABSTRACT

A rail based mobility system includes various vehicles and railway infrastructure, and related methods of operation, that are able to operate efficiently in an on-demand fashion. The system can include a plurality of transportation vehicles, rail tracks with one or multiple junctions, and systems and methods of modifying and enabling road vehicles to use the rail tracks and mobility system.

### CROSS-REFERENCE TO RELATED APPLICATION

This application claims the benefit of U.S. Patent Application No. 63/237,028, filed Aug. 25, 2021, which is incorporated by reference herein in its entirety.

### FIELD

This disclosure relates to a system for operating individual rail vehicles on rail tracks.

### BACKGROUND

Traditional railway infrastructure is underutilized as it is highly limited by common signaling and switching systems, being the primary bottlenecks in preventing continuous vehicle flow. Existing railways typically accommodate freight trains and scheduled passenger trains, with large gaps between each as they are required to maintain substantial headway distances. The necessity of these headway distances results from two primary factors. Due to their heavy mass and little friction with the tracks, stopping distances are exceptionally long and reduced headways would increase the probability of collision. In addition to this, conventional wayside switching actuation is slow, and necessitates around one unit of stopping distance for rail traffic as well. Improvements to the use and operation of railway infrastructure are desirable.

### SUMMARY OF THE INVENTION

This disclosure is directed to a system of independently operating rail vehicles, which is optimum in terms of energy efficiency, convenience, and safety.

An object of the invention, according to a first aspect, is providing a system of independently operating rail vehicles, the system including an on-demand, self-actuating rail vehicle mobility system for the transport of passengers and goods, including rail corridors with a nonstop, continuous stream of vehicles travelling at a specified speed, railway vehicles and roadway vehicles modified to drive on railway tracks, infrastructure-to-vehicle power supply systems, simplified types of railway track installations, high-speed corridors and system entry facilities for roadway vehicles, goods and passengers; additionally, an installation of railway infrastructure on roadway surfaces for the creation of a railway corridor isolated from roadway vehicle traffic.

According to a second aspect, systems and methods are provided for transporting roadway vehicles along the system without modification using a self-propelled platform vehicle, the method being such that it includes a self-propelled platform vehicle driving on rails to transport roadway vehicles along the rail tracks, having a design such that the platform surface has an optimal loading position setting and optimal driving position setting, components for fastening roadway vehicles to the platform, infrastructure-to-vehicle power system collection components, wheel slip prevention components, and vehicle coupling mechanisms.

According to a third aspect, systems and methods are provided for the use of existing road vehicles in a rail vehicle system, the method being such that it includes one or more of the following technologies, including a railway wheel which fits onto roadway vehicle hub connections, enabling the modification of roadway vehicles, enabling them to drive on rail tracks, a sub-vehicle frame assembly having attachment points for the mounting of components beneath the vehicle, a mechanical self-switching assembly having extending pins, making contact with the sides of rail tracks to orient the vehicle when necessary, an electrified rail collection wheel assembly using an electrically conductive bearing-pin assembly and insolating mounting components, and/or an extendable cog gear mounted to the vehicle to prevent wheel slip of the main vehicle wheels.

According to a fourth aspect, systems and methods are provided for favorable implementation of infrastructure for the rail vehicle system as defined earlier for vehicle operation, the method being such that it includes one or more of the the following technologies, including a semi-enclosed apparatus containing an conductive infrastructure-to-vehicle power supply contact surface and cog rack infrastructure, an assembly of metal or steel flats or pieces installed on a roadway surface facilitating the travel of railway vehicles, as well as the continued use of the roadway by roadway vehicles, and/or a track junction or switch which can facilitate the operation of a vehicle-mounted mechanical self-switching assembly.

### BRIEF DESCRIPTIONS OF THE DRAWINGS

FIG. 1 illustrates railway vehicles or roadway vehicles, modified for use in the proposed rail mobility system, which execute a desired switching actuation setting at each track junction, determining route of travel without requiring the setting, movement or actuation of infrastructural components.

FIG. 2 illustrates a functioning freeway, on a portion of which the proposed rail mobility has been installed and is in operation with vehicle exit and merging sections connecting the main through track to another section of the rail mobility system crossing the freeway through an underpass.

FIG. 3 illustrates a near view of the proposed rail mobility system in operation on a freeway surface, having been isolated from roadway vehicle traffic by a solid barrier and tire-catching depression cut out from the roadway surface.

FIG. 4 illustrates a cross-section view of the proposed rail mobility system in operation on a freeway surface, having been isolated from roadway vehicle traffic by a solid barrier and tire-catching depression cut out from the roadway surface.

FIG. 5 illustrates a stationary platform vehicle in the process of loading or unloading a roadway vehicle, the rotating platform portion of the vehicle in the angled loading position (relative to the rail tracks) allowing a roadway vehicle to access the platform from a loading deck beside the railway tracks.

FIG. 6 illustrates a driving platform vehicle transporting a roadway vehicle on its platform surface, the rotating platform portion of the vehicle in the parallel driving position (relative to the rail tracks).

FIG. 7 illustrates a stationary platform vehicle in the process of loading or unloading a roadway vehicle, the elevating platform portion of the vehicle in the elevated loading position, allowing a roadway vehicle to access the platform from a loading deck at the end of the tracks.

FIG. 8 illustrates a driving platform vehicle transporting a roadway vehicle on its platform surface, the elevating platform portion of the vehicle in the non-elevated driving position.

FIG. 9 illustrates the outer face of a railway wheel for roadway vehicles, which upon fastening to the hub connection of a roadway vehicle can enable roadway vehicles to use the proposed rail mobility system.

FIG. 10 illustrates a railway wheel for roadway vehicles resting on a rail.

FIG. 11 illustrates a railway wheel for roadway vehicles with attachment points on the hub connections on a roadway vehicle axle, aligned for attachment.

FIG. 12 illustrates a side view of a roadway vehicle modified to travel on rail tracks using railway wheels for roadway vehicles.

FIG. 13 illustrates a sub-vehicle frame assembly without attachments and not attached to any vehicle, having a swiveling front portion to accommodate rotation by a vehicle's front wheels in case the steering system is not fixed in place.

FIG. 14 illustrates a sub-vehicle frame assembly attached to a vehicle's wheels (vehicle not pictured) having the following attachments; a mechanical self-switching assembly adjacent to each each wheel, an electrified rail collection wheel assembly, an extendable cog gear assembly, and an electrified rail collection shoe.

FIG. 15 illustrates a top view of a sub-vehicle frame assembly attached to a vehicle's wheels (vehicle not pictured) having the following attachments; a mechanical self-switching assembly adjacent to each each wheel, an electrified rail collection wheel assembly, an extendable cog gear assembly, and an electrified rail collection shoe.

FIG. 16 illustrates a mechanical self-switching assembly having two contact pins, showing adjacent components of the sub-vehicle frame assembly to which it is attached.

FIG. 17 illustrates a front view of a mechanical self-switching assembly having two contact pins, showing adjacent components of the sub-vehicle frame assembly to which it is attached.

FIG. 18 illustrates an extendible electrified rail collection wheel assembly.

FIG. 19 illustrates an extendible cog gear assembly.

FIG. 20 illustrates a railway track with the partially enclosed railway vehicle power delivery system installed between the main tracks.

FIG. 21 shows a cross section of a railway track with the partially enclosed railway vehicle power delivery system installed between the tracks, having a cog rack secured at the inner base of the partial enclosure (including an enlarged view).

FIG. 22 shows a one lane of a street with steel flat rails installed onto the roadway surface with an inward extension (in the direction of the opposite segment with which a track is formed) to accommodate the insertion of a bolt or other fastening device into the roadway surface, as well as a bolt in alignment for the securing of the segment (including an enlarged view).

FIG. 23 shows a top view of a steel flat rail with a fastening extension and a bolt.

FIG. 24 shows a cross-section view of a steel flat rail with an inward fastening extension (in the direction of the opposite segment with which a track is formed) and a bolt driven through, fastening the segment to the roadway surface.

FIG. 25 shows a track junction or switch which can facilitate the operation of a vehicle-mounted mechanical self-switching assembly, having stationary main rail track segments and an inner gap on each rail resembling a flangeway.

FIG. 26 shows a cross-section view of a track junction or switch which can facilitate the operation of a vehicle-mounted mechanical self-switching assembly, having stationary main rail track segments and an inner gap on each rail resembling a flangeway.

### DESCRIPTION OF THE PREFERRED EMBODIMENTS

The following is a detailed description of various embodiments of the present invention. The aforementioned drawings are referenced to serve as some, not all, of the visual embodiments of the invention. It should be understood that all description and drawings are to be considered exemplification of the invention and is not intended to limit the invention to the specific embodiments described and illustrated below.

The systems and methods described herein, and individual components thereof, should not be construed as being limited to the particular uses or systems described herein in any way. Instead, this disclosure is directed toward all novel and non-obvious features and aspects of the various disclosed embodiments, alone and in various combinations and subcombinations with one another. For example, any features or aspects of the disclosed embodiments can be used in various combinations and subcombinations with one another, as will be recognized by an ordinarily skilled artisan in the relevant field(s) in view of the information disclosed herein. In addition, the disclosed systems, methods, and components thereof are not limited to any specific aspect or feature or combinations thereof, nor do the disclosed things and methods require that any one or more specific advantages be present or problems be solved.

As used in this application the singular forms “a,” “an,” and “the” include the plural forms unless the context clearly dictates otherwise. Additionally, the term “includes” means “comprises.” Further, the term “coupled” or “secured” encompasses mechanical and chemical couplings, as well as other practical ways of coupling or linking items together, and does not exclude the presence of intermediate elements between the coupled items unless otherwise indicated, such as by referring to elements, or surfaces thereof, being “directly” coupled or secured. Furthermore, as used herein, the term “and/or” means any one item or combination of items in the phrase.

As used herein, the term “exemplary” means serving as a non-limiting example, instance, or illustration. As used herein, the terms “e.g.,” and “for example,” introduce a list of one or more non-limiting embodiments, examples, instances, and/or illustrations.

Unless explained otherwise, all technical and scientific terms used herein have the same meaning as commonly understood to one of ordinary skill in the art to which this disclosure belongs. Although methods and materials similar or equivalent to those described herein can be used in the practice or testing of the present disclosure, suitable methods and materials are described below. The materials, methods, and examples are illustrative only and not intended to be limiting. Other features of the disclosure are apparent from the detailed description, claims, abstract, and drawings.

Rail transportation has the potential to be a highly effective solution to high traffic volumes as a form of high-density, sustainable transportation for widespread use. To become an attractive option for travelers, physical and technological improvements can be developed to address current limitations. Vehicle stopping distances will be reduced if lighter vehicles are used, more so if a cog gear system is utilized, preventing wheel slip.

Additionally, reassigning switching mechanisms to vehicle components would provide vehicle users with simple control of route alteration without the need for centralized line control. These changes could facilitate a highly flexible, on-demand transportation system, similar to existing road vehicle systems.

Environmentally sustainable transportation is not widely used. This is because there are significant issues with existing sustainable systems. Electrified rail transport is most notably difficult to access for most travelers, due to inflexible routes, schedules and points of system entry. In regions with highly developed railway systems, rail transportation usually only accounts for around twenty percent of personal transportation due to these issues of convenience and logistics.

In populated areas, a rail-based system is likely to be more feasible, popular and cost-effective than a fully electric road vehicle system. This results from several fundamental shortcomings of existing electric automobiles.

Batteries for electric road vehicles typically require highly refined materials, making them expensive and difficult to recycle. Electrified rail vehicles can easily facilitate a catenary wire or third-rail grid connection, likely negating the need for a chemical battery and reducing overall vehicle weight. A grid connection would also increase the maximum rate of energy recaptured during regenerative braking. Rail vehicles also experience less energy loss to friction than road vehicles, as the rolling resistance experienced by steel wheels on rails is approximately one tenth of that for rubber tires on a road. The overall efficiency of a rail-based electric vehicle system will require substantially less grid power generation, and therefore result in lower emissions than an equivalent road-based system.

Many other issues with electric road vehicles remain unresolved, including scarcity of charging locations and relatively high vehicle cost. These concerns may prevent electric automobiles from becoming a highly accessible alternative to conventional transportation systems, and therefore pose a major challenge to the widespread adoption of environmentally sustainable transportation.

Disclosed herein are systems that utilize automobiles and similar vehicles on a railway as a low-energy alternative to road vehicles and air transport for private individuals and businesses. Novel systems that enable automobile and electric automobile owners to modify existing vehicles to operate in a rail-based mobility system are described herein.

Such systems can include, as described herein, one or more of the following:
rail wheels which can be installed at the hub connections of conventional automobiles;
an automobile platform for travel on rail systems;
electric motors and power collection apparatuses, which can replace combustion drivetrain and fueling systems in automobiles;
onboard switching actuation systems which control vehicle movements and actuating components intended for vehicle-infrastructure interaction;
computerized line monitoring and vehicle telecommunication data exchange systems, and
a user interface for travelers using individual rail vehicles.

Repurposing existing roadway infrastructure for the rail system can substantially decrease installation time and infrastructural cost. The flattening and paving of a compacted ground surface is already an intermediate step of track installation in some modern methods.

Described herein is a new system of rail transportation that provides greater societal benefits than existing modes of environmentally sustainable transport. The system can use modified automobiles, and other similar vehicles, which operate on-demand for users without necessity for centralized control, signalization, or route planning. The system includes various novel technologies to facilitate the improved introduction of such a system into widespread use.

Vehicles on the system can operate on-demand based on user requests, without prior system scheduling. Users are able to access the system at system points of entry, using a hailing or rental service, or by simply initiating a vehicle route plan in the case of vehicle ownership. The rail vehicle can then semi-autonomously execute the route plan using wirelessly transmitted data including line speed, line closures and track junction information. Vehicles can actuate vehicle self-switching at track junctions based on the initiated route plan and centrally transmitted line data. Users can actively modify vehicle route selection without requiring approval or communication from a central control system.

The introduction of this system can begin with a single line installation, periodically adding line connections with new mainline track junctions, connecting residential and commercial areas around the mainline for additional points of system access.

In some embodiments, a grid connection via an onboard power collection system, and/or conductive contact with a third-rail or catenary wire system along the tracks can be utilized. Total vehicle energy use can be substantially reduced because of this method of power delivery. Substantial energy savings can also be achieved using steel wheels on steel rails, substantially reducing energy losses due to friction in comparison to road vehicles.

As conventional automobiles currently exist in abundance, the system will allow the use of modified conventional and electric automobiles to accelerate system access. Much of the technology in this invention has been created for the effective facilitation of these modifications.

Railway replacement wheels for an automobile can be installed with relative ease and allow immediate rail capabilities for an automobile on which they have been installed. These wheels disclosed herein can provide both the hub connection sections of road wheels and the contact surfaces of railway wheels.

In some embodiments, the wheels can have a similar profile to conventional automobile wheels, surrounding vehicle braking assemblies, allowing the original assemblies to be used for braking when using rail tracks.

A third-rail or catenary wire power collection system can be added. For example, in some embodiments a moving arm with conductive wires and a conductive contact surface can be added, as well as internal wire connections to motor controllers and electrical circuitry.

In some embodiments, a self-switching system can be installed on the vehicle prior to their driving on the system. In one implementation, the vehicle self-switching actuating assembly can comprise roller wheels which extend down and make contact with the outer surface of rail tracks prior to a track junction.

An alternative to automobile modification for use in the system is a self-propelled automobile rail platform, as discussed herein. In this embodiment, road vehicles will be able to drive onto platforms at specified locations along the line, and use the rail system similarly to modified automobiles driving directly on the system. The automobile rail platform will allow road vehicles to drive on road surfaces for journey segments where rails are not available, and quickly transfer onto the rail system at aforementioned locations. Road vehicles can be secured manually or automatically to the automobile rail platform using integrated fastening components. The self-propelled automobile rail platform will use third-rail or catenary wire power collection equipment for electrical traction, and conventional railway wheels or other wheels similar to railway replacement wheels for an automobile.

As disclosed herein, a semi-enclosed vehicle power delivery system may be used in the system. This system will reduce the risk of accidental electrical conduction and electrification. The assembly comprises an outer non-electrified enclosure, which surrounds an electrically conductive contact assembly, partially surrounded by electrically insulating materials. Vehicles will have power collection components which enter the enclosure to make contact with contact components, facilitating electrical conduction between the vehicle and power delivery system. The semi-enclosed vehicle power delivery system may comprise a cog rack for vehicle component interaction, preventing vehicle wheel-slip on the rails.

New technology and efficient methods for line installation can provide for improved installation feasibility. As described herein, rail lines can be installed on existing roadway infrastructure, and create more useful transportation corridors. This has previously not been possible with conventional rail, given the great forces imparted on infrastructure by conventional rail vehicles.

Installing steel flats on a roadway surface for rail vehicles can facilitate mixed-use road and rail vehicle traffic lanes, or alternating use lanes. Using steel flats as rails, likely for lower-speed lines on residential streets can allow greater mainline access, and more favorable points of system entry for travelers. Installation of the flat rails would also be simpler, less expensive, and use spaces which are already designated for vehicle use.

To prepare the steel flats for use as effective rail tracks, extensions and fittings may be added which will aid in the installation and fastening of the assembly. Following this, one side of the rail flats may be placed atop a roadway surface and given optimal positioning prior to installation using bolts or other fastening devices. Once one side of the flat rails has been fastened to the roadway, the opposite side may be placed and roughly aligned with the first. Measuring devices may then be used to more accurately align the second rail assembly. Once this step is completed, the fasteners may be installed one at a time, confirming that optimal spacing is maintained whilst installing each of the fasteners.

Portions of existing roadway infrastructure may also be converted for use solely by rail vehicles, with tracks and equipment accommodating high-speed rail vehicles in the invention. This conversion would involve the installation of railway tracks and support components, as well as fasteners, electrification equipment, sensing equipment, telecommunications equipment, and rail corridor isolation equipment, such as trenches, walls and other barriers. The repurposing of road surfaces for the rail vehicles may allow greater infrastructural usefulness, and a relatively economical means of expanding public access to sustainable transport.

With a converted roadway rail installation, travelers using the rail system may save substantial time compared to those taking equivalent journeys in adjacent road vehicles using some of the same superstructures. Rail vehicles are capable of traveling safely at much higher speeds than road vehicles. Introducing autonomous driving technology would also be much simpler for rail vehicles, as they need not account for many of the variables required to facilitate safe driving on a roadway. The isolation barriers of the converted roadway will also decrease the probability of incidents and external interference on the rail line.

The above objects and benefits of the various mobility systems described herein are further illustrated by the following descriptions and discussion of the figures.

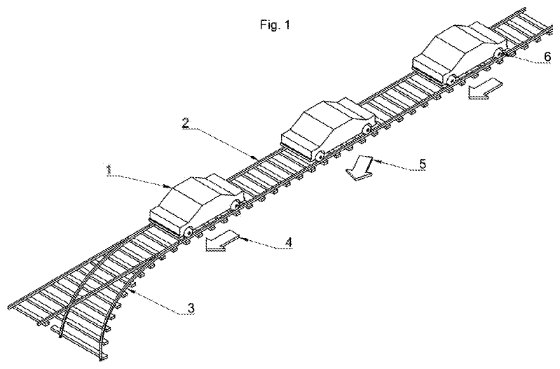

FIG. 1 shows a vehicle 1 using a mobility system as described herein. Rail tracks 2 provide for the conveyance of the vehicle 1 and track junctions 3 determine a preferred route, along with the corresponding actuate switching components. Arrow 4 illustrates a vehicle 1 engaging a right/straight switching actuation and arrow 5 illustrates a vehicle engaging a left/straight switching actuation. Rail wheels 6 are attached to an automobile at a hub connection.

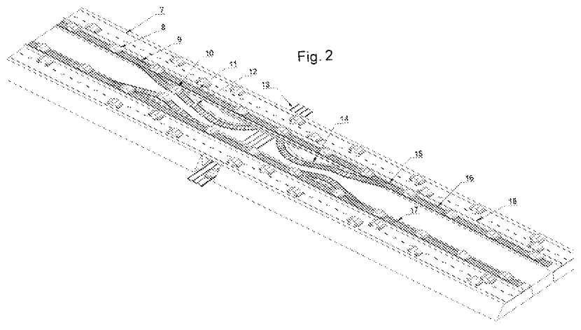

FIG. 2 illustrates a freeway roadway 7 with the proposed mobility system installed on the inner shoulders and/or in the median and isolated from roadway traffic, in a right-hand drive region. A vehicle 8 is illustrated on the proposed mobility system and a track junction 9 is provided for vehicles entering the isolated freeway corridor from other sections of the proposed mobility system. Vehicle 10 is shown preparing to merge into the isolated freeway corridor, and gap 11 is provided in the vehicle flow on the isolated freeway corridor. An on-ramp 12 is provided on the isolated freeway corridor as shown in FIG. 2. Another, non-freeway corridor 13 is illustrated in FIG. 2.

An off-ramp 14 is shown in the isolated freeway corridor, with a track junction 15 for vehicles leaving the isolated freeway corridor, and a main track 16 is provided on the isolated freeway corridor. Another main track 17 is provided for traffic in the opposing direction in the isolated freeway corridor. A barrier 18 dividing roadway vehicle traffic from the isolated freeway corridor of the proposed mobility system can also be provided.

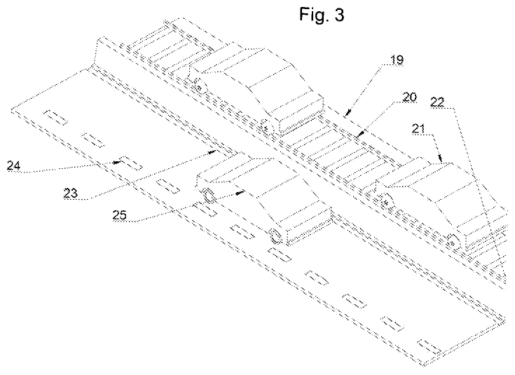

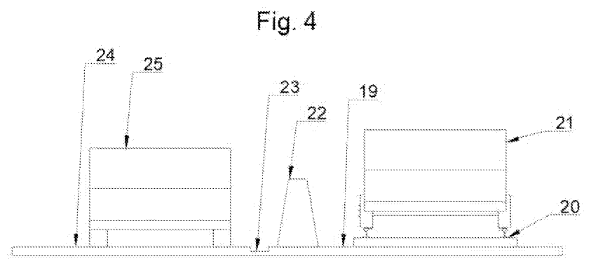

FIGS. 3 and 4 illustrate a roadway surface 19 (used for road vehicle traffic), and a railway track assembly 20 with a rail vehicle 21 using the rail system. A physical barrier 22 can be provided for isolation and safe operation of the rail system while adjacent to road vehicle lanes and corridors.

A depression 23 can be provided between road vehicle lanes and rail vehicle lanes to prevent road vehicle incidents from interfering with rail system operation. A portion 24 of roadway surface can be provided to continue to facilitate road vehicle traffic. In this regards, a road vehicle 25 is show traveling adjacent to a rail line which has been installed on the motorway.

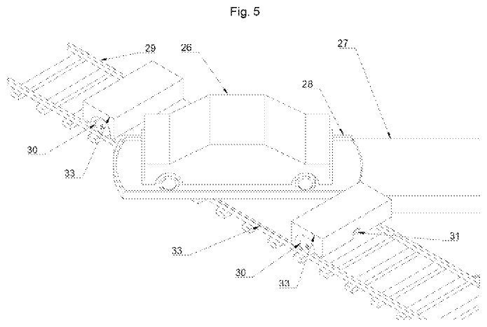

FIG. 5 illustrates a roadway vehicle 26 which has driven onto the rotating platform surface of a platform vehicle, with a roadway vehicle loading platform 27 and a rotating platform portion 28 of the platform vehicle in the angled loading position.

Railway tracks 29 can be used by the platform vehicle to transport the roadway vehicle along with railway wheels 30 of the platform vehicle. A coupling mechanism 31 of the platform vehicle can also be provided.

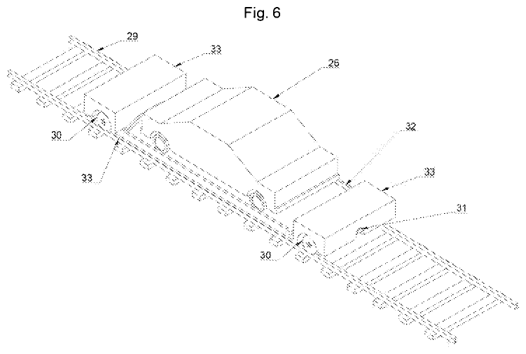

As shown in FIGS. 6-8, rotating platform portion 32 of the platform vehicle can be moved in the parallel driving position for transport on the rail system. A primary body portion 33 can include the platform vehicle housing drivetrain and electrical components.

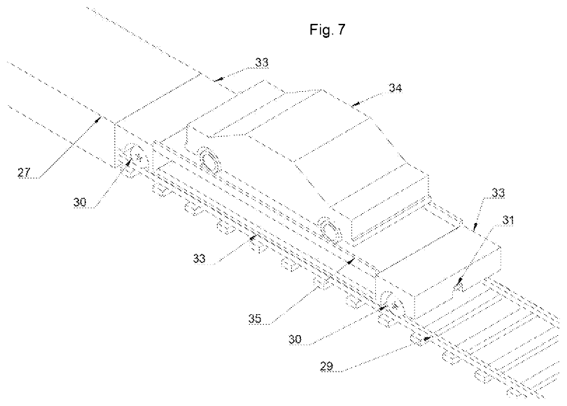

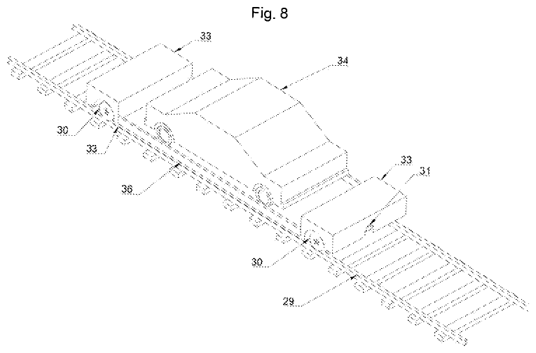

FIG. 7. illustrates a roadway vehicle 34 which has driven onto the elevating platform surface of a platform vehicle. The elevating platform portion 35 of the platform vehicle is illustrated in the raised loading position and FIG. 8 shows the elevating platform portion 36 of the platform vehicle in the lowered driving position.

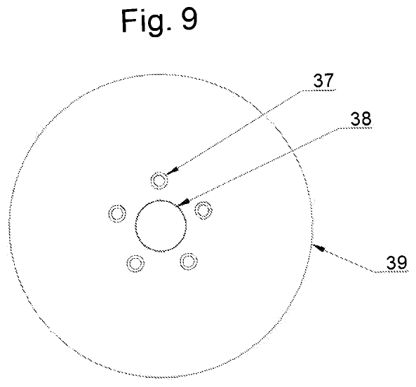

As shown in FIG. 9, specially positioned lug holes 37 can receive lug bolts of a conventional automobile hub, a pin 38 for the attachment of additional unsprung vehicle-mounted components can be provided, and an outer face 39 of wheel with automobile hub connection features can also be provided.

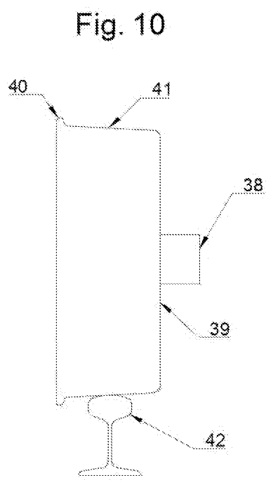

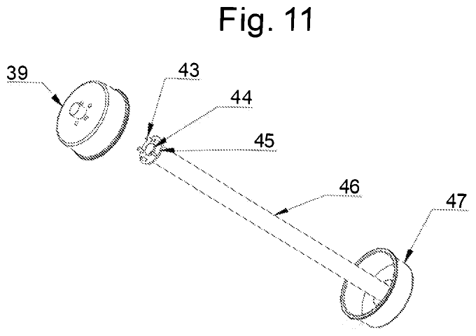

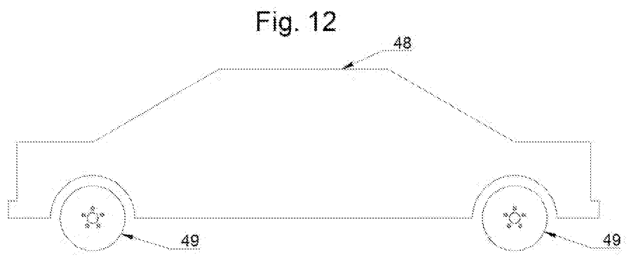

Referring to FIG. 10, a flange section 40 of the wheel can be provided along the non-facial edge of the contact surface 41 which rolls along the rails 42 of the rail tracks which come into contact with wheel at the contact surface. As shown in FIG. 11, lug bolts 43 of an automobile hub, a center bore fitting 44 of an automobile hub, a wheel contact face 45 of an automobile hub, a vehicle axle 46, and a rail wheel 47 for an automobile attached to the opposite side of the vehicle axle can be provided to secure an automobile 48 (e.g., as shown in FIG. 12) with rail wheels 49 as disclosed herein.

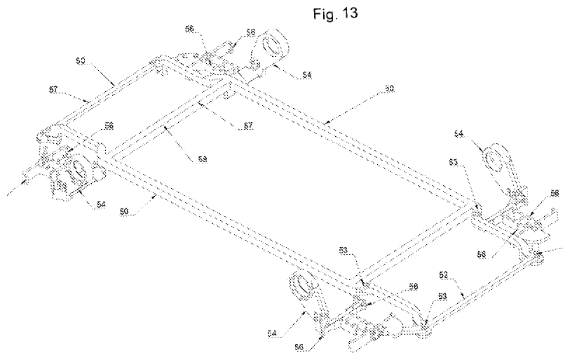

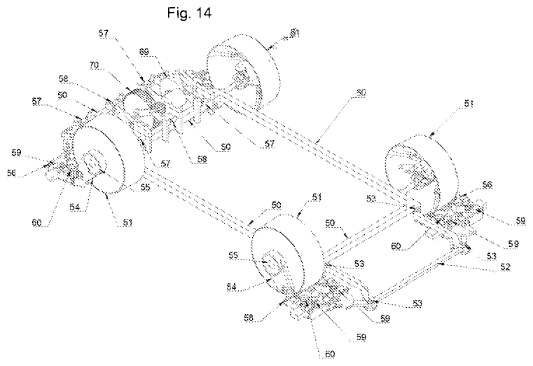

FIGS. 13-15 discloses various components of an exemplary sub-vehicle frame assembly 50 (main frame), including main vehicle wheels 51, pivoting end section of the sub-vehicle frame assembly 52, hinges between main frame assembly and pivoting end section 53, sub-vehicle frame attachment joint connection 54 to the outer bearing-pin assembly on the main vehicle wheels, outer bearing-pin assembly 55 on the main vehicle wheels, attachment points 56 for mechanical self-switching assemblies, attachment points 57 for electrified rail collection components, attachment points 58 for a cog-gear assembly, and mechanical self-switching assembly 59.

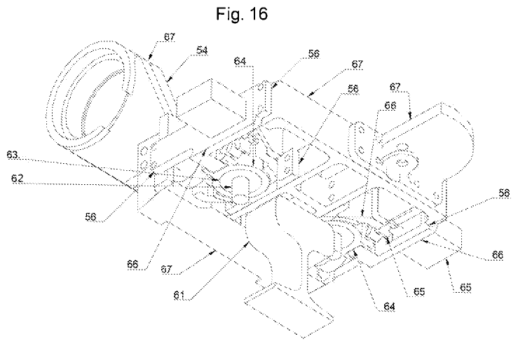

FIG. 16 illustrates a mechanical self-switching assembly having two contact pins, showing adjacent components of the sub-vehicle frame assembly to which it is attached. The assembly and related components can include an upper face 60 of contact pin in the mechanical self-switching assembly, railway track 61, contact pin 62 (in an extended position), bearings that hold the contact pins 63, a contact pin-bearing housing element 64, a contact pin actuation sub-assembly 65, and a main housing 66 for elements of the mechanical self-switching assembly.

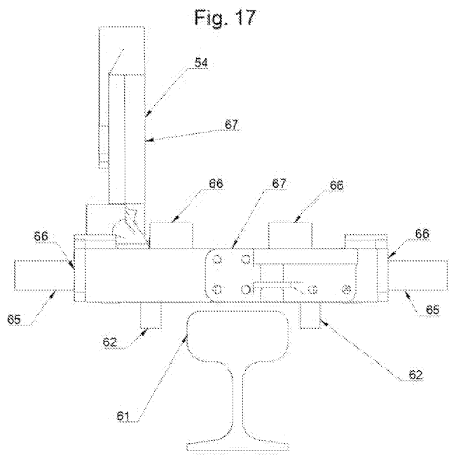

FIG. 17 illustrates a front view of the mechanical self-switching assembly having two contact pins, showing adjacent components of the sub-vehicle frame assembly to which it is attached. In particular, frame components 67 are illustrated adjacent to the mechanical self-switching assembly.

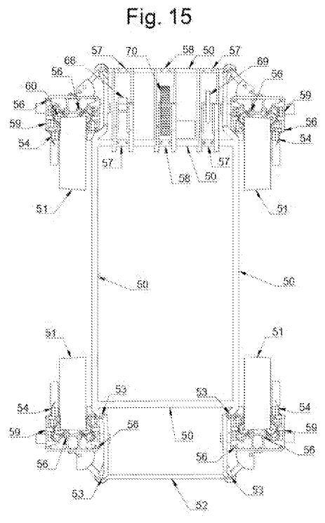

Referring to FIG. 15 again, an electrified rail collection shoe 68, an electrified rail collection wheel assembly 69 mounted to vehicle and positioned above the electrified rail infrastructure, and an extendable cog gear assembly 70 are shown.

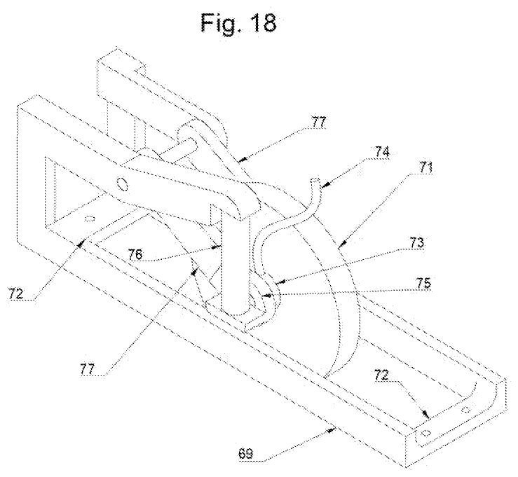

FIG. 18 illustrates an extendible electrified rail collection wheel assembly 69, with an electrified rail collection wheel 71, vehicle sub-frame mounting points 72 on the electrified rail collection wheel assembly.

FIG. 18 also shows and electrically conductive bearing component 73, an electrical wire 74 connecting a non-rotating portion of the electrically conductive bearing component 73 to electrical terminals on the vehicle, and an electrically isolating component 75 between the electrically non-rotating conductive bearing component and frame attachment arms. In some embodiments, a spring assembly and actuation mechanism 76 and attachment arms connecting 77 can be provided to connect the electrically insulating section and wheel to the assembly frame.

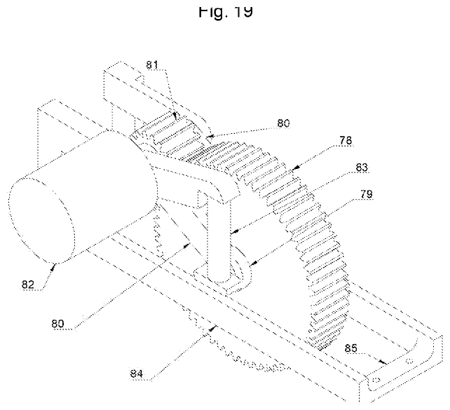

FIG. 19 illustrates an extendible cog gear assembly. In particular, a main cog gear 78 is coupled to a bearing-pin assembly 79 of the main cog gear, and an attachment arm 80 of the cog gear assembly. A first gear 81 in the cog gear assembly gear train is directly or indirectly affixed to the shaft of a motor 82 to drive the gear train. An actuation mechanism and spring assembly 83 can be provided for the extendable cog gear, and the cog gear assembly 84 can be mounted to a vehicle with positioning above the cog rack infrastructure. The cog gear assembly can have one or more vehicle sub-frame mounting points 85 on the cog gear assembly.

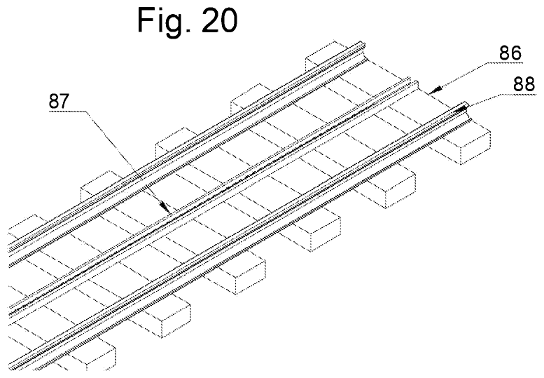

FIG. 20 illustrates a railway track with the partially enclosed railway vehicle power delivery system installed between the main tracks. The infrastructural fixation surface 86 for the vehicle power distribution apparatus, a semi-enclosed vehicle power distribution apparatus 87, and rail tracks 88 of the rail-based system are illustrated.

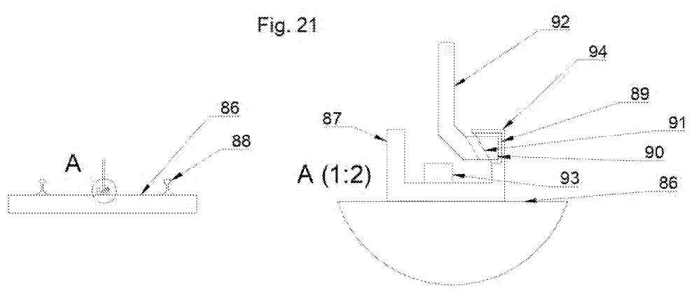

FIG. 21 shows a cross section of a railway track 88 with the partially enclosed railway vehicle power delivery system installed between the tracks, having a cog rack secured at the inner base of the partial enclosure (including an enlarged view). As shown in FIG. 21, an electrical insulator 89 is provided to maintain grounding of the outer body of the vehicle power distribution apparatus. The system includes a semi-enclosed conductor portion 90 of the vehicle power distribution apparatus with a conductive contact portion 91 of the vehicle arm power collection apparatus 92. The cog rack apparatus 93 is inside the semi-enclosed vehicle power distribution apparatus 87. An electrical conductor enclosure portion 94 of the vehicle power distribution apparatus is also provided.

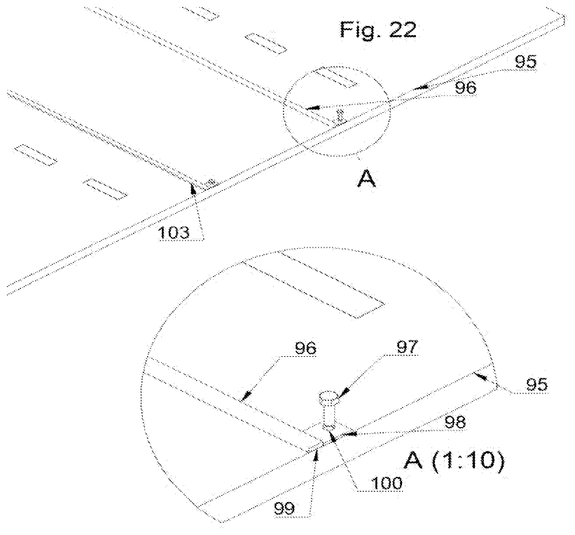

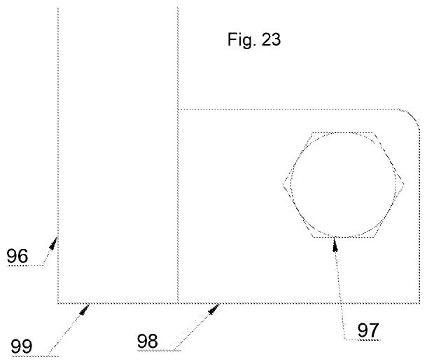

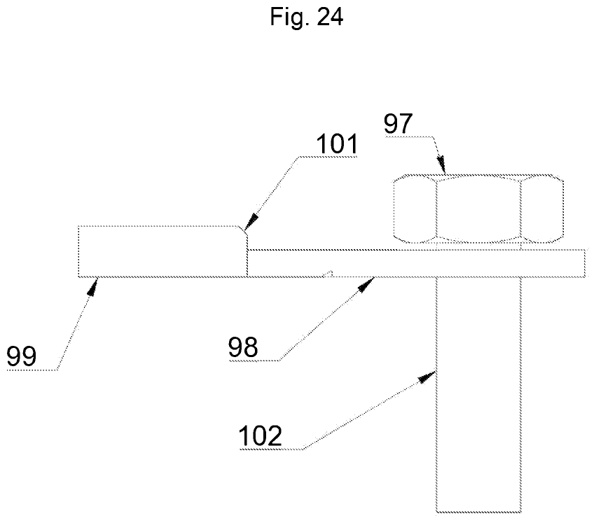

FIG. 22 shows a lane of a street with steel flat rails installed onto the roadway surface with an inward extension (in the direction of the opposite segment with which a track is formed) to accommodate the insertion of a bolt or other fastening device into the roadway surface, as well as a bolt in alignment for the securing of the segment (including an enlarged view). The roadway or street surface 95 has one or more steel flats 96 installed atop the surface for use as rails in a track system. One or more bolts 97 or other fastening devices can fasten the steel flats to the roadway during installation. Extensions 98 can be provided to facilitate fastening of the flats to the roadway, with a bolt hole 100 or other fastener insertion point. As shown in FIGS. 22-24, in some embodiments flats 99 can have an end face 99 abutting extension 98. As shown in FIG. 24, in some embodiments, the rails (e.g., steel flat rails) 101 can have a modified edge profile to better accommodate a vehicle component contact (such as curved or beveled edges). In addition, the bolt can have a portion 102 that extends into the roadway or ground beneath the rail to secure the rail track apparatus in place. Referring again to FIG. 22, one or more additional rails 103 can be secured to the roadway surface, substantially parallel to the first rail 96.

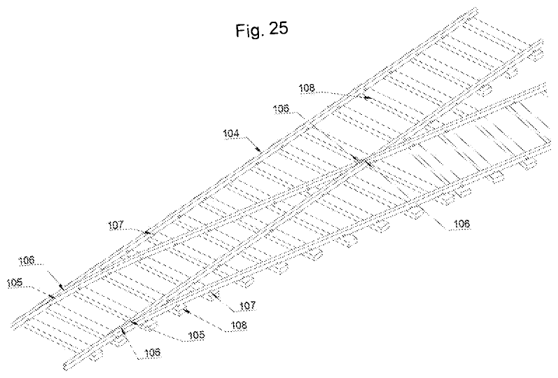

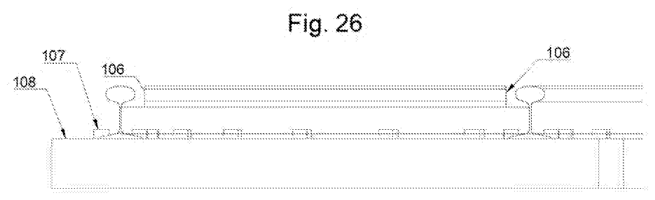

FIG. 25 shows a track junction or switch which can facilitate the operation of a vehicle-mounted mechanical self-switching assembly, having stationary main rail track segments and an inner gap on each rail resembling a flangeway, and FIG. 26 shows a cross-section view of a track junction or switch which can facilitate the operation of a vehicle-mounted mechanical self-switching assembly, having stationary main rail track segments and an inner gap on each rail resembling a flangeway. The track system can include one or more track junctions 104, a plurality of stational track segments 105, one or more constant flangeway-like switching pin gaps, a plurality of railway ties 108, and a plurality of railway track fastening components 107.

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. I therefore claim as my invention all that comes within the scope and spirit of these claims.

1-35 (canceled).

36. A mobility system including rail track corridors configured for on-demand operation, in which track switching operations are induced by vehicle-mounted actuation at any of several Y-junctions, not requiring actuation or movement of wayside or infrastructural components, the mobility system comprising:
one or more rail tracks configured for traveling thereon one or more rail vehicles;
a plurality of railway Y-junctions which allow one or more of the rail vehicles to direct themselves onto a desired segment of the rail tracks using one or more vehicle-mounted self-switching mechanisms;
a plurality of loading areas configured for systematic loading of any one of or any combination of passengers, goods or road vehicles into or onto system vehicles, the loading areas including any one of or any combination of stations, platforms, loading turnouts, loading tracks, loading loops, parking places, hailing areas, vehicle waiting areas, loading ramps, and facilities;
one or more infrastructural components inducing or powering vehicle propulsion and supplying auxiliary power to the rail vehicles or road vehicles;
one or several vehicle-mounted propulsion means and means for receiving power from the infrastructural components;
one or more regulated corridors including barriers to isolate the rail vehicles or the road vehicles traveling on the regulated corridors from unforeseen variables; and
one or more line monitoring and regulation systems, where any one of or any combination of cameras and sensors, the line monitoring and regulation systems being configured to provide an operation selected from the group consisting of any one or any combination of:
monitor traffic and identify potential interferences to traffic traveling along the regulated corridors;
transmit and receive information to and from the rail or road vehicles to ensure safe passage of the rail or road vehicles on the regulated corridors; and
ensure a safe passage of the rail or road vehicles on the regulated corridors at a determined travel speed or a determined average travel speed;
wherein the Y-junctions allowing vehicle entry and exit along one or several of the regulated corridors, at which the rail or road vehicles enter the regulated corridor in a controlled manner based on information received from the line monitoring and regulation systems, and actuate the vehicle self-switching mechanisms to leave the regulated corridors when necessary;
wherein the vehicle self-switching mechanisms being configured to regulate switching performed at the Y-junctions without infrastructural actuation, or to improve vehicle-track alignment as a possible measure of derailment prevention.

37. The mobility system of claim 36, wherein the regulated corridors include one or more rail corridors in which a continuous or semi-continuous stream of vehicles travel in a specified direction at a specified speed or average speed defined for each given corridor or track without needing to slow or stop periodically, except when accelerating after loading or unloading and when decelerating in preparation for loading or unloading operations.

38. The mobility system of claim 37, wherein the rail corridors being partially composed of one track width, where convoys of one or several vehicles alternate direction in a regulated sequence, such that vehicles travel from both directions in a way that they will reach multi-track segments quite simultaneously, to mitigate a necessity for the rail or road vehicles to slow down or come to a stop during such passing operations.

39. The mobility system of claim 36, further comprising a railway track installation comprising steel flat-type pieces that have been fastened to a roadway surface to enable roadway and railway vehicle traffic on a single lane or travel corridor.

40. The mobility system of claim 36, wherein the mobility system is implemented in a form of railway track installations including the rail tracks installed atop any one or any combination of freeway shoulders, freeway lanes or other roadway surfaces which have been closed to and isolated from roadway vehicle traffic, including components relevant to conventional railway installations.

41. The mobility system of claim 36, further comprising:
platform-rail-vehicles or platform vehicles which travel on the rail tracks, the platform-rail-vehicles or the platform vehicles are configured for transporting the road vehicles; and
wherein the road vehicles are systematically equipped or made compatible for travel on the platform-rail-vehicles or otherwise in the mobility system.

42. An installation of rail tracks and associated infrastructure atop a freeway, a roadway or a paved surface, having been closed to and isolated from roadway traffic, pedestrians, bicycles, wild animals and other potential physical hindrances, the installation comprising:
a road surface being a freeway surface, a roadway surface or a paved surface, the road surface being is closed to road traffic and physically isolated from road traffic; and
one or more railway track installations on the road surface, the railway track installations comprising railway track fastening and support components selected from the group consisting of bolts, screws, sleepers, ties, hardened slabs, spikes, clips and other components used in conventional railway infrastructure.

43. The installation of claim 42 further comprising one or more infrastructural components inducing or powering vehicle propulsion and supplying auxiliary power for a vehicle, including any one or of or any combination of an electrified rail-type apparatus, an overhead catenary-type apparatus, and a linear motor-type apparatus, a linear alternator-type apparatus, a linear induction generator-type apparatus, and any relevant power supply, power conversion and control apparatuses therefore.

44. A platform-rail-vehicle or vehicle with a platform surface which drives on rails for a purpose of transporting one or more road vehicles along rail tracks, having an ability to be propelled independently or semi-independently of other vehicles, the platform-rail-vehicle comprising:
a plurality of wheels suitable for travel on rail tracks;
one or more onboard motorized drive means configured for vehicle propulsion;
one or more surfaces onto which one or more road vehicles may drive, to be fastened, securely resting during transport operations conducted by the platform-rail-vehicle;
one or more components or mechanisms to enable affixing of roadway vehicle components of the road vehicle to the platform-rail-vehicle to prevent undesired rolling or movement of the road vehicle;
one or more rotating platform apparatuses for the road vehicles to drive onto and off of the platform-rail-vehicle in a direction non-parallel to a travel direction of the platform-rail-vehicle, or one or more elevating platform apparatuses for the road vehicles to drive onto and off of the platform-rail-vehicle, moving the elevating platform apparatuses and the supported road vehicle into a lowered position for operations of the road vehicles being transported by the platform-rail-vehicle to reduce overall height during travel;
one or more vehicle-mounted energy storage devices and corresponding systems and apparatuses; and
one or more self-switching assemblies of the platform-rail-vehicle, enabling the platform-rail-vehicle to regulate switching performed at Y-junctions without infrastructural actuation, or to improve vehicle-track alignment as a possible measure of derailment prevention.

45. The vehicle of claim 44, further comprising vehicle-mounted power-drawing or traction elements including any one of or any combination of an electrified-rail shoe-type apparatus, an electrified-rail contact wheel-type apparatus, an overhead catenary pantograph-type apparatus, a linear motor-type apparatus, a linear alternator-type apparatus, a linear induction generator-type apparatus, and any relevant power supply, power conversion and control apparatuses therefore.

46. A vehicle-mounted mechanical self-switching assembly of one or multiple moveable pins to be actuated into various positions either inducing or avoiding contact with sides of rail tracks when necessary, enabling a rail vehicle to regulate switching performed at junctions without infrastructural actuation by enabling forces to act through the moveable pins, guiding the vehicle onto a determined or desired track or route, or improving vehicle-track alignment as a possible measure of derailment prevention, the self-switching assembly comprising:
one or more moveable contact pins which can be actuated in one or multiple directions, to either induce or avoid contact with sides of rail tracks when necessary or desired;
one or more bearings which surround one or multiple of the contact pins above their contact surface to create a bearing-pin assembly, joining one or more of the contact pins to a portion of the self-switching assembly between the contact pins and a vehicle mounting point;
a housing element partially enclosing the bearing-pin assembly, keeping the bearing-pin and bearing elements together while joining to the self-switching assembly and the vehicle;
one or more actuation sub-assemblies, including actuation mechanisms and corresponding control components connecting to relevant adjacent assemblies, physically joining the bearing-pin assembly or a bearing-pin housing element to the portion of the self-switching assembly mounted to the vehicle or an intermediate vehicle-affixed components; and
one or more main housing elements forming an enclosure or semi-enclosure around one or more of the actuation sub-assemblies and bearing-pin housing elements.

47. An electrified rail collection roller wheel assembly, mounted directly to a rail vehicle or vehicle configured to drive on rails, or mounted to an intermediate vehicle-mounted component or assembly, making contact to infrastructural electrified rail-type infrastructure when desired or necessary, the roller wheel assembly comprising:
a wheel having a conductive surface for contact with infrastructural electrified rail-type conductive surfaces;
one or more electrically conductive bearing components which transmit electricity between rotating and non-rotating components attached directly to the bearing components to which collection roller wheel components are attached;
one or more non-rotating attachment arms connecting electrically isolating components to the vehicle or to intermediate vehicle-mounted components or assemblies;
one or more electrical wires or other connections which electrically connect the electrified non-rotating components with one or multiple power terminals on the vehicle or intermediate vehicle-mounted components or assemblies, providing the vehicle with power from the infrastructure by way of the collection roller wheel;
one or more electrically isolating components or assemblies connecting electrified non-rotating components attached to the collection roller wheel with fixed attachment points on the vehicle or on intermediate vehicle-mounted components or assemblies;
any one of or any combination of spring assemblies, damper assemblies, spring-and-damper assemblies, bolts, screws, nuts, rods and other fastening devices to fasten or enable optimal force interaction between components in the electrified rail collection roller wheel assembly; and
one or more actuation mechanisms to move the collection roller wheel in one or multiple directions to adjust its position and facilitate optimal contact between the collection roller wheel and infrastructural electrified rail-type components.

48. A moveable cog gear assembly attached to a rail vehicle or vehicle configured to drive on rail tracks or intermediately to vehicle-mounted assemblies, interacting with one or multiple infrastructural cog rack segments between or beside the rail tracks when extended appropriately, otherwise being in a retracted position to avoid contact and corresponding friction forces, the cog gear assembly comprising:
a main cog gear with several teeth having characteristics suited for contact with infrastructural cog rack segments or components;
one or more bearing-pin assemblies, attaching a center of the main cog gear to one or multiple attachment arms and therefore to the vehicle;
one or more attachment arms connecting a bearing-pin assembly of the main cog gear to the vehicle;
a gear train consisting of multiple gears including the main cog gear, transferring rotational forces between a vehicle-mounted motor and cog rack infrastructure by way of the main cog gear;
one or more electric motors to regulate rotation and rotational forces of the main cog gear by way of the gear train;
any one of or any combination of spring assemblies, damper assemblies, spring-and-damper assemblies, bolts, screws, nuts, rods and other fastening devices to fasten or enable optimal force interaction between components in the moveable cog gear assembly; and
one or more actuation mechanisms to move any one of or several of the main cog gear and members of the gear train in one or multiple directions to adjust their position and facilitate optimal contact or absence of contact between the main cog gear and infrastructural cog rack components or segments.

49. A track segment system installable atop a roadway or roadway-like surface, acting as a low-profile form of railway tracks, to facilitate travel by railway vehicles and roadway vehicles on the same surface, the track segment system comprising:
multiple flat metal segments placed atop and fastened to roadway or roadway-like surfaces, with each pair being spaced by a track width, on which rail vehicles may drive and roadway vehicles may pass over;
one or more modifications to the metal segments for a purpose of fastening down the metal segments to the roadway surface, such as holes, inward or outward extensions, bolts, clips, spikes or other fastening components;
chamfered, filleted, or otherwise modified edge profiles to facilitate improved interaction between vehicle components and the metal segments;
additional metal segments and electrical equipment forming a railway-to-vehicle power distribution network; and
electronic sensing and wireless communication equipment along the metal segments to monitor track activity, traffic, and other measures to assist with an operation of a travel corridor.

50. A track junction or switch to enable or optimize an operation of a vehicle-mounted mechanical self-switching assembly according to claim 36, the track junction or switch comprising:
a plurality of stationary railway track segments;
one or more additional guide rails or check rails, to contact pin components of outer vehicle self-switching assemblies possibly preventing derailment during switching in a case of any undesirable or unexpected forces or movements; and
railway fastening components to secure down the railway track segments including those used in conventional rail track installations.
